(19) United States
(12) Patent Application Publication
(10) Pub. No.: US 2004/0215659 A1
(43) Pub. Date: Oct. 28, 2004

(54) Network image server

(76) Inventors: Christian Robert Maurice Singfield, Shorncliffe (AU); Andrew Niven, Coorparoo (AU)

Correspondence Address: BAKER BOTTS L.L.P., 2001 ROSS AVENUE, SUITE 600, DALLAS, TX, 75201-2980, US

(21) Appl. No.: 10/485,713

(22) PCT Filed: Aug. 1, 2002
(86) PCT No.: PCT/AU02/01029

(30) Foreign Application Priority Data
Aug. 2, 2001 (AU) PR 6784

(51) Int. Cl. G06F 17/00

(52) U.S. Cl. 707/104.1; 707/10

(57) ABSTRACT

An image server provides several displayed image resolution. Original image (28) is scanned at high resolution. This high resolution image is divided into rectangular image tiles (35) each of the same resolution. A degree of overlap between adjacent tiles (35) can be arbitrarily get during input image processing. An imageID of each image tile (35) is stored in a relational database. The imageID is a unique identifier for the file name of the associated file. Each tile (35) is stored as graphics format The graphics file is an image file which is stored externally of the database. Tiles, graphics file and database entries for each tile are created for each level of image resolution. Tiles for each successive resolution level are generated from tiles of previous higher resolution level or from the original (highest resolution) by dividing up the highest resolution image into tiles and ‘re-sampling’ each of those tiles at a lower resolution.

### FIELD OF THE INVENTION

The present invention relates to the display of images over a network.

### BACKGROUND OF THE INVENTION

Graphical applications generate massive collections of large files. Such graphical applications include, but are not limited to, medical imaging, mapping and topographic earth survey, video and multi-dimensional seismic images. It is desirable that central collections of such images be made available for remote viewing. It is also desirable that users who are viewing such images at remote displays be able to zoom into and out of an image, and be able to pan to a different region of the image. The remote display may be any suitable equipment, which includes (but is not limited to) immersive 3-D displays, high-end scientific or graphics workstations, personal computers and laptop computers, palm-held computers and mobile telephones.

U.S. Pat. No. 6,182,127 to Cronin, et al. addresses the perceived limitations of the known methods of viewing digital document images on networked workstations. One of these perceived limitations is that the workstations use proprietary workstation application software. The Cronin et al. patent addresses this limitation by utilising a Web browser on the workstations, and an image server which is adapted to receive requests from the Web browser in Uniform Resource Locator (URL) code, to identify the image file and format selections being requested, to compose the requested view into a grid of view tiles, and to transmit HTML code to view the tiles to the requesting Web browser. However the disclosure of Cronin et al. is computation intensive in that the composition of the requested view into a grid of tiles is done ‘on-the-fly’ as the server receives each image request, although if a required tile is already stored in the ‘view tile cache’ then that stored copy of the tile will be used rather than generate a new tile. The image view server may also generate tiles in anticipation of the next view request.

The Microsoft TerraServer project is another example of a network client/server system for the display of images. This system is publicly available at http://terraserver.microsoft.com, and is described in Barclay, T., et al., Microsoft TerraServer: a Spatial Data Warehouse, Microsoft Corporation Technical Report MS-TR-99-29, June 1999. TerraServer is a database of topographic maps and satellite generated earth photographs. As with the Cronin et al. patent, a user can mouse-click at a point within an image which is presented in a web-page, to zoom into a higher resolution display of a portion of that image. A ‘panning’ facility is also available. TerraServer involves the generation of a ‘pyramid’ of image tiles with the resolution of each image corresponding to its level in the pyramid. Unlike the situation with the Cronin et al. patent, the image tiles in TerraServer are not generated on-the-fly in response to an image access request. Instead they are generated contemporaneously with the loading of image data into the relational database that is the basis of TerraServer. Each tile image, about 10 KB average size, is placed directly in a column of type image, there is no image data outside the database.

An image server system such as TerraServer which is based on storage of image data in table rows in a relational database is computationally and resource intensive in the maintenance of the image data. For example, and depending on the type of Database Management System (DBMS) if an image requires replacement for any reason, the original image data may not actually be replaced in the database tables. Instead, the relevant table row is marked as inactive and a new table row containing the image data is created. The actual management of this process depends on the underlying DBMS (which is usually proprietary). Also, because the original image data is not actually deleted, it remains in the database, consuming disk space, until the database is in some way compacted or re-generated. Alternatively, and again depending on the underlying DBMS, the disk space occupied by a ‘deleted’ image may well be freed up for re-use, but not actually be re-used until an entire contiguous ‘page’ of storage is available.

U.S. Pat. No. 6,192,393 B1 (Tarantino et al.) describes a method and system for viewing images over a server-client network, in this case specifically panorama images, and provides for zooming in, zooming out and panning. Tarantino et al. uses the ‘FlashPix Format’ files of ‘The Digital Imaging Group’. This file uses a pyramid of non-overlapping image tiles with resolution which depends on the level in the pyramid, which are stored in a single FlashPix file. A FlashPix file is a multi-resolution tiled image format. A FlashPix image is constructed by starting with an original image and recursively sub-sampling it at half the resolution. FlashPix images are more complicated than simple raster images. The individual 64×64 pixel tiles into which each image level is partitioned are usually JPEG compressed for Internet applications. Furthermore, the FlashPix format specification requires that the tiles be stored within a Microsoft OLE structured storage file.

The present invention also seeks to provide an image server system which allows more flexibility in manipulation of the underlying data than does various previously described systems.

The present invention also seeks to provide an image server system in which image files can be manipulated without the need for an update or other query language operation within the database.

The image server of the present invention can be used over a public network such as the Internet to display images using client imager display software running on a range of different hardware. Some client hardware may have relatively small display screens. For example, laptop computers with small display screens, capable of displaying images of no more than 800×600 pixels. Other client hardware may be capable of displaying images of 1600×1200 pixels on a 21 inch (or larger) monitor. Various embodiments of the present invention also aim to customize the image data to take advantage of enhanced capabilities of the client hardware.

With some prior art image servers the process of panning can be discontinuous in that the currently displayed image may be cleared from the client display, and then a new image built up on a clean display area. This process can be disconcerting to the viewer because the viewer may not be sure that features of the original object have not be missed in the jump from one displayed image to the next.

Some of the embodiments of the present invention accordingly seek to ensure that, on the display of a successive image, some of the area of the preceding image is initially displayed in the display area and then the remainder of the new image is built up.

### SUMMARY OF THE INVENTION

In one aspect the present invention accordingly provides a method of segmenting a file, which method includes the steps of:

(a) obtaining a file and storing an identifier of the file in a database;

(b) notionally dividing at least part of the file into a plurality of regions;

(c) for each of the regions:

(i) creating a new file which contains data which is related to the content of the region;

(ii) storing each new file outside the database; and

(iii) storing an identifier of each new file within the database.

In another aspect the present invention accordingly provides a method for displaying images to at least one display client over a network, which method includes the steps of:

(a) obtaining an original image file of an image at an original resolution and storing an identifier of the image in a database;

(b) dividing at least part of the area of the image into a plurality of regions; and

(c) creating an image file for each region at a subsequent resolution which is lower than the original resolution and storing an identifier of each image file of each such region in the database.

It is preferred that steps (b) and (c) are performed recursively to produce a hierarchy of image files at decreasing resolution levels.

It is preferred that the regions into which each image is divided are rectangular regions.

It is preferred that, at each resolution level, each image region overlaps with adjacent image regions.

It is preferred that the database is a relational database.

It is preferred that each identifier of an image is the image file name.

It is preferred that each image file is a graphics format file.

It is preferred that images are provided to a display client using hypertext transfer protocol (http).

Alternatively, it is preferred that images are provided to a display client using file transfer protocol (ftp).

It is preferred that the display client is polled by the image server to ascertain at least one of:

the maximum displayable picture size in pixels; and

the physical size of the picture display area.

It is preferred that the original image file is generated from any one of:

a frame of a video file;

a vector graphics file; and

a SEG Y file.

It is preferred that at least one of the plurality of regions into which the image file is divided overlaps with at least one other such region.

It is preferred that the part of the area of the image file that is divided into a plurality of regions is selected by a process which includes the step of analyzing the contents of the image file to identify objects which are depicted in that file.

In yet another aspect, the present invention accordingly provides an image server for the display of images to at least one image display client over a network, which image server includes:

means for storing a set of images, which set of images includes a hierarchy of image files at decreasing resolution levels; and

a database which contains data on each image in the set of images, which database includes data which identifies the location of each image in the stored collection of images.

In yet another aspect the present invention provides apparatus for segmenting a file, which apparatus includes means for:

(a) obtaining a file and storing an identifier of the file in a database;

(b) notionally dividing at least part of the file into a plurality of regions; and

(c) for each of the regions:

(i) creating a new file which contains data which is related to the content of the region;

(ii) storing each new file outside the database; and

(iii) storing an identifier of each new file within the database.

In yet another aspect the present invention provides an image server for displaying images to at least one display client over a network, which image server includes:

(a) means for obtaining an original image file of an image at an original resolution and storing an identifier of the image in a database;

(b) means for dividing at least part of the area of the image into a plurality of regions; and

(c) means for creating an image file for each region at a subsequent resolution which is lower than the original resolution and storing an identifier of each image file of each such region in the database.

In yet another aspect the present invention provides a method of operating an image server to display images over a network to at least one display client, in which method image data is stored at the image server and that image data has been generated by a method which includes:

(a) obtaining an original image file of an image at an original resolution and storing an identifier of the image in a database;

(b) dividing at least part of the area of the image into a plurality of regions; and

(c) creating an image file for each region at a subsequent resolution which is lower than the original resolution and storing an identifier of each image file of each such region in the database.

In yet another aspect the present invention provides a method of operating an image display client to display images received over a network from at least one image server, in which method the images displayed at the client are derived from image data that is stored at the image server and that stored image data has been generated by a method which includes:

(a) obtaining an original image file of an image at an original resolution and storing an identifier of the image in a database;

(b) dividing at least part of the area of the image into a plurality of regions; and

(c) creating an image file for each region at a subsequent resolution which is lower than the original resolution and storing an identifier of each image file of each such region in the database.

### DESCRIPTION OF THE DRAWINGS

FIG. 1 is a schematic diagram illustrating the components of an image client/server system according to one embodiment of the present invention.

FIG. 2 is a drawing illustrating one aspect of the operation of an image display client according to that embodiment of the present invention.

FIG. 3 is a drawing illustrating another aspect of the operation of an image display client according to that embodiment of the present invention.

FIG. 4 is a drawing showing the partition of an original image into a plurality of regions according to that embodiment.

FIG. 5 is a drawing showing the relationships among data tables of a database according to the present embodiment.

FIG. 6 is a drawing showing a file directory tree structure for image files.

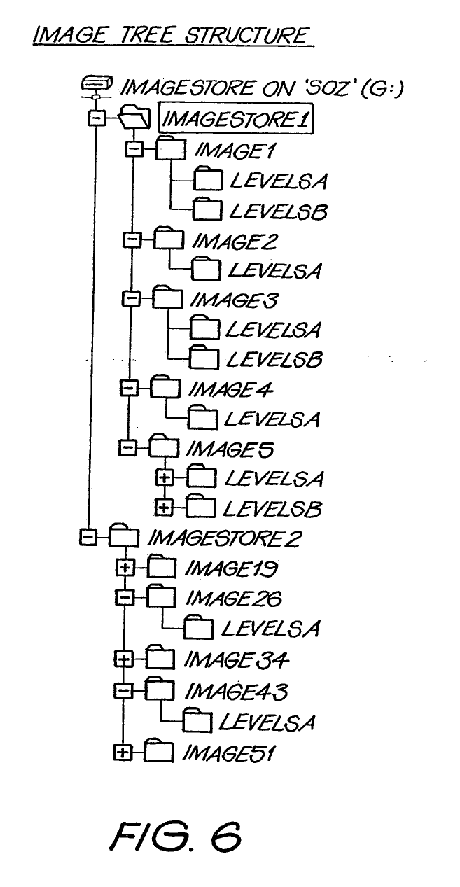

### DESCRIPTION OF PREFERRED EMBODIMENTS OF THE INVENTION OVERVIEW OF OPERATION AS PRESENTED TO A USER

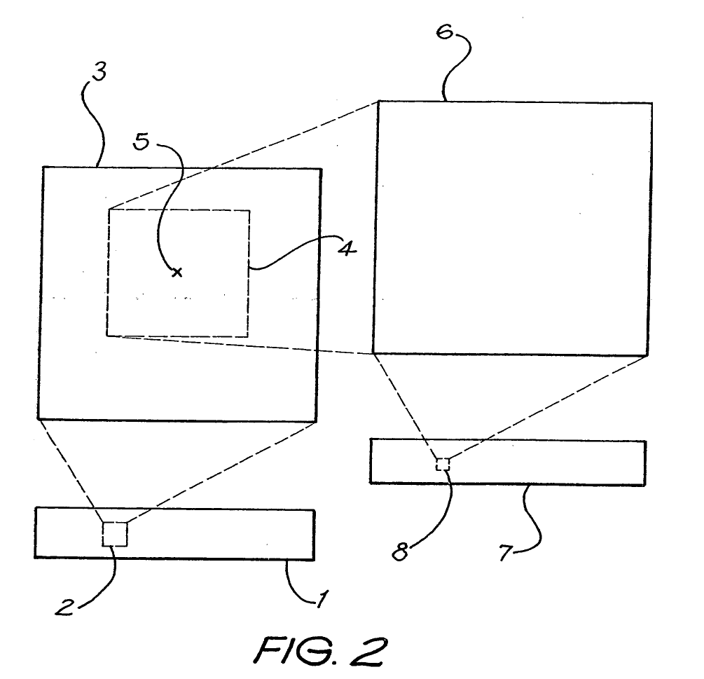

The image server according to the present invention works in conjunction with display client software, which in the present preferred form of the invention is a web browser, on a user workstations. FIG. 2 illustrates one aspect of the operation of an image display according to one embodiment of the present invention. For these purposes of illustration, FIG. 2 is based on the images that a user will typically see when the image data is images scanned from a cross-sample of a geological survey core.

When a user logs onto the image server and selects an image for display, the initial display on the user terminal shows the images depicted as items 1 and 3 in FIG. 2. The item 1 is referred to as an index image, and in the present case it is a low resolution image of a one-meter length of a cross-section of a geological core. The square image 3 is a higher resolution image of a portion of the index image 1. The location of the region which is shown in image 3 within the index image 1 is shown on the index image 1 by the location of the window 2. The portion 2 of the index image 1 that is initially displayed is arbitrarily chosen.

The user can zoom into the image 3 by mouse-clicking on a region of that image. For example, if the user wanted to more closely examine the feature 5 within image 3, the user mouse clicks on or near that feature. Images 6 and 7 in FIG. 2 illustrate the sequence of display events that follow when the user chooses to zoom in on feature 5 and the zoom ratio is set at 200%. At this zoom ratio, the image 3 on the workstation is replaced by the image 6, which occupies the same area on the workstation screen as did the image 3. However, image 6 displays one quarter as much of the surface of the index image as did image 3. This is shown by displaying the window 8 on the index image 8 at one quarter the size (in area) as was the window 2 on index image 1. (It will be appreciated that the zoom ratio of 200% is chosen in this embodiment for illustrative purposes only. As is described below, the zoom ratio can be arbitrarily determined, but is set during the course of image input processing.)

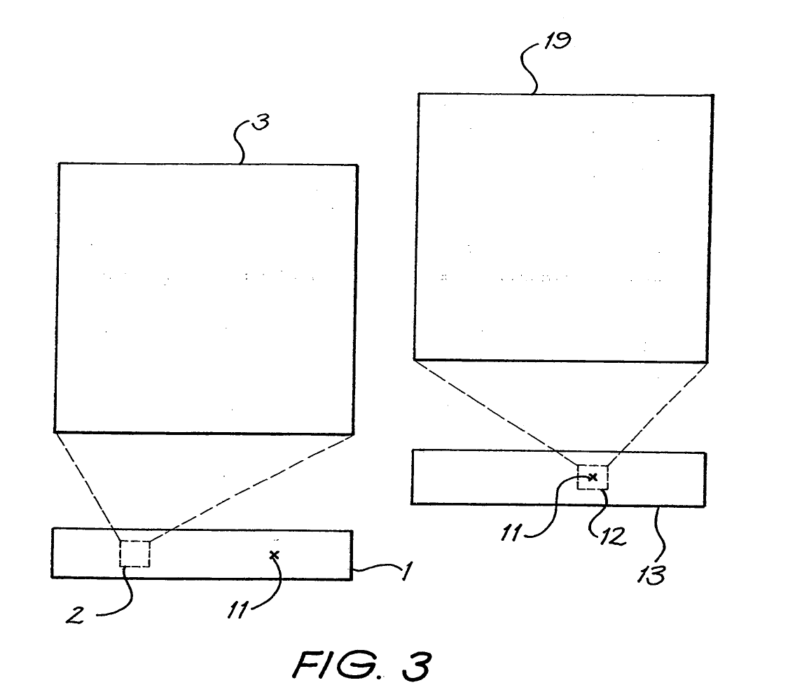

FIG. 3 illustrates another aspect of the operation of the image display according to the present embodiment of the invention. FIG. 3 also shows the items which are depicted as items 1 and 3 in FIG. 2. Item 1 is the index image, and the square image 3 is the higher resolution image of the portion of the index image 1 that is shown by the window 2 on image 1. FIG. 3 however illustrates the sequence of events when a user ‘pans’ to a different region of the index image 1. For example, the user may want to more closely examine the feature which is shown by reference numeral 11 on index image 1. The user mouse clicks on that on or near that feature, and the image 3 is replaced by the image 14. Image 14 is at the same zoom ratio as is image 3, but shows the region of the index image 13 which is shown by the location of the window 12.

Similarly, the present invention provides a facility for the user to ‘zoom out’ of images, and a facility to ‘pan’ within an image.

In the case where a user pans within an image, in preferred forms of the invention the panning is not discontinuous in that the a portion of the originally displayed image that is stored locally within the client is first re-displayed within the image display area and then new image material is built up in the image display area.

### Overview of the Operation of the Image Server Hardware and Software

The present embodiment of the invention provides for eight levels of resolution of displayed image. The highest resolution level (level 8 in the zoom hierarchy) is actually the resolution at which the original core was image-scanned. The mechanics of generating the images that are managed by the image server preferably includes the following steps.

The original object (for example, a prepared cross-section of an oil-well core) is scanned at a very high resolution.

This high resolution image is divided into a number of (rectangular) image tiles of the same resolution. There is an overlap between adjacent tiles. That degree of overlap can be arbitrary, and is set at the time of input image processing.

Each tile is stored as a graphics format image.

An image ID (‘ImageID’ in the system's data dictionary) for each tile is stored in a relational database. The ImageID is a unique identifier for the file name of the associated tile.

The graphics file for the tile is not stored within the relational database, but as described above the database has an identifier for the image file which is stored externally of the database. Preferred forms of external include SAN (Storage Area Network) or RAID storage. As described above, this storage of image files outside the RDBMS can result in economies of database processing and storage. Similarly, the storage of the image files for the tiles outside the RDBMS allows for reprocessing of the image files in various ways without the need for query, update or other query language operations within the RDBMS. For example, the degree of overlap between the image tiles can be achieved by image reprocessing which is external to the RDBMS.

Tiles, a graphics file for each tile, and database entries for each tile are created for each level of image resolution. According to one preferred embodiment of the invention, tiles for each successive resolution level are generated from tiles for the previous (higher resolution) level. According to another preferred embodiment of the invention, tiles for each successive resolution level are generated from the original (highest resolution) image by again dividing up the highest resolution image into tiles and ‘re-sampling’ each of those tiles at a lower resolution. This process produces about 3,000 images for a one-meter length of core sample.

According to yet further preferred embodiments of the invention, not all the area of the image is tiled. For example, in the case where the original image is of a geological sample, image analysis algorithms are used to identify lithography zones in the image and/or to eliminate artifacts (such as the sample tray) and then only the areas of interest are tiled.

### Description of the Hardware and Software

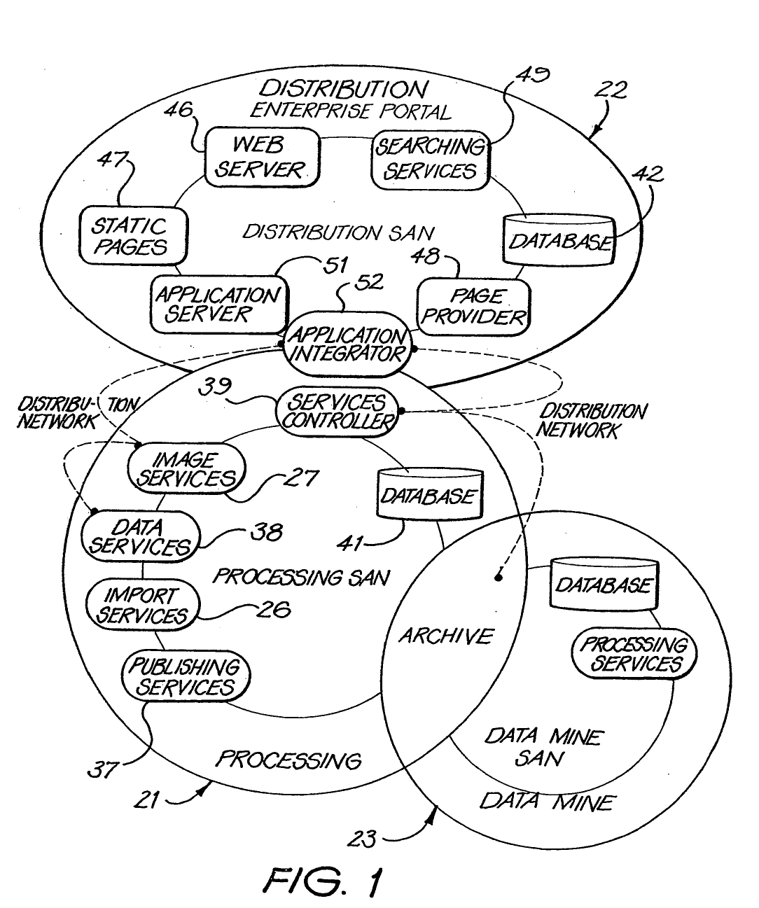

FIG. 1 is a schematic diagram of an image server according to the present embodiment of the invention.

Overview of FIG. 1

The image server as illustrated in FIG. 1 includes a processing node 21 and a distribution node 22. According to alternative preferred embodiments, the invention also includes an archiving and/or data mining node 23. The Processing node 21 receives source images and processes them in a form suitable for distribution. According to the present embodiment of the invention, the processing node 21 also receives and processes data which is associated with the images. The distribution node 22 distributes images to display clients. The archiving and/or data mining node 23 handles the archiving of low-usage images, and/or processes images to generate data about the physical characteristics of the object that is the subject of the image. (For example, in data mining mode, the module may analyse the image of a geological core sample to calculate the percentage, by area, that each type of rock occupies in that sample. The data mining aspects of this node are not the subject of the present patent application.)

Although in FIG. 1 the processing node 21 and the distribution node 22 are closely located, it is to be understood that the physical implementation of these nodes need not be closely located. For example, in the case of the application of the invention to geological survey data, the processing node 21 may be located close to a drilling rig and the distribution node 22 located remote from the drilling rig. However, in some physical embodiments of the invention, these two nodes could be located on the same machine.

Each of the processing, distribution and archive/data mining nodes includes a number of sub-nodes.

Components of FIG. 1

In the processing node 21, the import services sub-node 26 supplies the mechanism for the import of images into the system. Its functions include: insuring that the processing node is authorised to accept the images that are presented to it, and to place those images in known locations in the processing node. Images can be delivered by a number of media. For example, in the case of capture of images of geological core samples, the camera or scanner that captures the images may be closely adjacent the processing node and directly connected to it. Alternative media for supply of source images include supply on magnetic tape, disk, and by file transfer protocol over a network.

According to one especially preferred form of the invention, the imported ‘image’ is a file in vector graphics form or containing other three-dimensional data, such as a SEG Y file. (A SEG Y file contains 4-D seismic survey information.) Vector graphics files are not image files as such. Instead, they contain data which specifies the co-ordinates of points and the description of geometrical forms which span between those points. Typical data in a vector graphics file includes, for example, the specification that an entity is a line, the beginning and end points of that line, and the thickness of that line. They thus contain data about three-dimensional objects. Images are normally created from vector graphics files and presented on the two-dimensional display of a computer monitor in a way that can create an illusion that the display is three-dimensional. For example, the viewer can be presented with the illusion of a walk-through of a three-dimensional structure. Display of images from vector graphics files currently requires graphics software which perform the computation-intensive processing to generate the two-dimensional images.

It will be appreciated that the two-dimensional view created from a vector graphics file for any particular view point can be tiled and stored at a hierarchy of zoom levels in an image server in accordance with the present invention. Such two-dimensional views can be generated and stored for a multitude of view points, giving the facility to simulate a walk-through of a three-dimensional structure to a users who are not equipped to run the 3-D graphics software on their workstations. The ‘graininess’ of such a walk-through depends on the separation between the view points for which tiled hierarchies of 2-D images have been generated.

In yet another especially preferred form of the invention, the imported ‘image’ is a video file such as an AVI file. Such a video file includes a sequence of successive frames which are displayed one after the other to create an illusion of movement of the objects which appear within the frames. It will be appreciated that each image frame within the video can be tiled and stored at a hierarchy of zoom levels in accordance with the present invention. For users who are running suitably modified display client software, this gives the facility to simulate the zooming into, out of, or panning within an animated video display.

Part of the process of image importing sets up the security levels which control which users may access images from the image server. The images which are made available from one image server may include images from more than one client. For example, one central image server may provide image services for more than one geological exploration enterprise. It is preferred that the access control involves the specification, for each input image, of access rights which follow the Unix categories of ‘global’, ‘group’ or ‘user’. These security levels can later be changed on-line by a user administrator who has an appropriate level of security, and any such changes are immediately active.

When an image has been imported, the services controller 39 (which is described in more detail below) is made aware that the image is ready for processing. The responsibility of the services controller 39 includes assigning responsibility for processing the images in an orderly manner.

The source images are then ‘tiled’ by the image services node 27. The images may not necessarily be processed in the order that they are presented to the import services node 26. Where, for example, the one processing node 21 is processing images from more than one client, the work of different clients may have different priorities.

Image tile Generation, Archiving and Re-Generation

According to various embodiments of the present invention, image tiles are generated, may be moved to off-line storage, or may be re-generated for optimal image presentation according to the capabilities of each client machine.

Initial Tile Generation

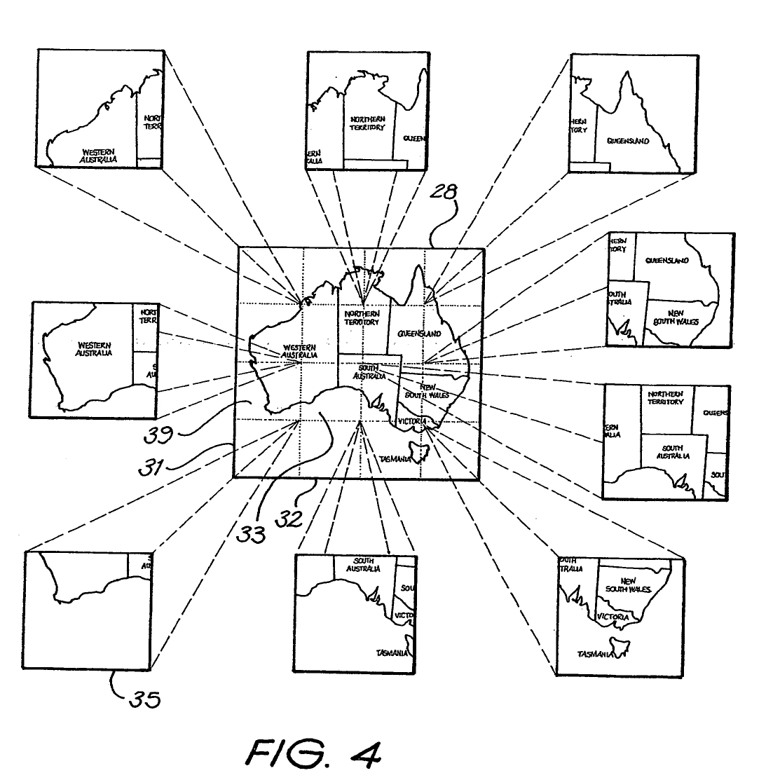

FIG. 4 illustrates how an original source image such as the map of Australia 28 is notionally divided into a 4×4 matrix of sixteen squares, such as the four adjacent squares 31, 32, 33 and 34. The contents of each image tile such as the tile 35 is the square grouping of each combination of four of these notional squares. An image file, at half the resolution of the image of the map 28, is generated for each tile. The image file for that tile is stored, and an entry is made in the database 41 giving the location of that image file. The image file for each of the image tiles such as the tile 35 is then further tiled in the same manner, with the same proportion of overlap between tiles and the image and image location data stored. This successive generation of tiles continues until a hierarchy of tiles is produced for all of the required resolution levels.

In embodiments of the invention which utilize an index image as part or the display on the display client, those index images are also generated at this stage.

According to alternative preferred embodiments of the invention, the tiling process is selective in that only selected areas of the original image are tiled, or tiled and retained. Using geological core as an example according to one of these embodiments, a software package is used to analyse the original image and identify the lithology boundaries in the core image. Thus having identified lithology zones of interest, the image server deletes all zoom tiles beyond a given zoom level from storage, leaving the zoom tiles for the zones of interest in storage.

Depending on the size and number of the images to be processed, the image services node 27 may be implemented as a task on a multi-tasking machine, or may be implemented as a task running on each of many machines.

Aesthetic considerations need to be taken into consideration when tiling an image. The first thing to consider is the height to width ratio, anything with a ratio of greater than 8:1 requires a different method of generating the index images to still aesthetic views of the areas currently being examined. The index requires two levels the first being a representation of the length of the image with a highlighted section for a predefined length currently being viewed, showing up to two times the length of the normal index image. The normal index images then represented only of the length highlighted in the first image.

The second aesthetic consideration is for image ratios of greater than approx 2.5:1. In this case the first level of tiles will be a square tile of the height or width of the index image, whichever is smaller. For example an index image of 1000×5000 should have the first levels of tiles at 1000×1000 with a 50% overlap. So this would produce 9 tiles at the first level. From here the normal tiling process takes over with level 2 being 500×500, level 3 250×250 and so on.

The tiling process that prepares an image for distribution depends on the following:

The final display size on the client's computer.

The amount of overlap between the tiles.

The maximum zoom level.

Image Indexing options.

The first stage of the processing is to generate a preview of the input image and the collection of the processing options. The physical size, in pixels, of the original image, the amount of overlap and the maximum zoom level determines the number of image tiles produced. FIG. 4 shows the individual tiles that are produced at the first level of zoom, when the degree of overlap between tiles is chosen to be 50%. The image server divides the width into 3 tiles for the first level and then further divides those tiles into 3 for subsequent levels. This means the following formula calculates the number of images across the width of the image for any level:

Tile Count=2^{Level}+2^{Level}−1;

So the following levels can be calculated:

| Level | Number of Tiles |
|---|---|
| 1 | 3 |
| 2 | 7 |
| 3 | 15 |
| 4 | 31 |
| 5 | 63 |
| 6 | 127 |
| 7 | 255 |
| 8 | 511 |

The width of the tile for each level can be calculated as:

Tile Width=Image Width/(Tile Count−(Tile Count−1)*overlap);

The Tile Height is then calculated based on the final output-viewing ratio of height to width. So if the final viewing window is 400×400 Pixels then the Tile Height=Tile Width.

If the final viewing window is 400×200 then the Tile Height=Tile Width/2.

Tile Height=Tile Width*(View Height/View Width);

The number of rows is determined by the height of the image. This means that the last row may overlap the previous row by more than the specified overlap.

If (Modulus (Image Height / (Tile Height / 2)) == 0) {
Row Count = New Image Height / (Tile Height / 2);
}
else {
Row Count = New Image Height / (Tile Height / 2) + 1;
}

This incorrect overlap for the last row can be distributed between the first and last rows so if the overlap was 60% for the last row this can be distributed in one of three rows:

The last row can take this full overlap.

The overlap can be distributed between the first and last rows.

In extreme cases the excess overlap can be distributed over the full height of the image.

The image is then cut up to the desired level and each image is resized to the viewing area required. The resized image is stored as a compressed JPG or other graphics file on the distribution system and an entry is made in the database for that zoom level.

When the image services node 27 has finished processing of an image, it notifies the services controller 39 of that completion of processing.

The archiving and retrieval of off-line images are also handled by the services controller 39. The archiving would normally be automated with a trigger level of 75-85% of on-line storage being used. The process is as follows.

The services controller measures the amount of on-line storage available in the node and calculates the available on-line storage. If this level drops below a preset limit then the archiving task takes over. The least frequently accessed images are found and moved to the archive. This would continue until another preset limit is reached OR all the images are currently being used. In the later case this is an indication the on-line storage is not large enough to handle the current images. In this case the administration can either add more on-line storage or move to a fragmented system where individual tiles are moved off-line. According to alternative embodiments of the invention, the least used images are found and deleted, to be re-generated if subsequently required.

Image Tile Regeneration

The initial tile generation as described above is done based on assumptions about the capabilities of the client hardware that will be used in displaying images. For example, for client hardware in the mining industry the most common image display resolution on the client workstations may be 1600×1200 pixels. In this case, the area available on the client workstation for display of the image may well be 800×800 pixels. If a user then logs onto the image server with a workstation that can achieve only 800×600 resolution, the 800×800 default image cannot be displayed. The image server then regenerates a 400×400 image ‘on the fly’ from the image tiles for the 800×800 image for display on this lower capability workstation.

The present embodiment of the invention includes a publishing services node 37 which can produce hard-copy output of various image data that is within the system.

The data services node 38 receives data, other than image data, that is to be associated with the image data. For example, where the image data is images of a geological core sample, the associated data includes data on the geographical location of the drill hole and the porosity of the material of the core sample. It is preferred that the geological location data includes the latitude and longitude of the well head and the depth of the core sample in that well. As is described below, this associated data is stored in the database sub-node 41.

The database 41 stores the data tables which are necessary for access to the separately stored image files. As described above, the database 41 also stores any associated data that is to be associated with the image files.

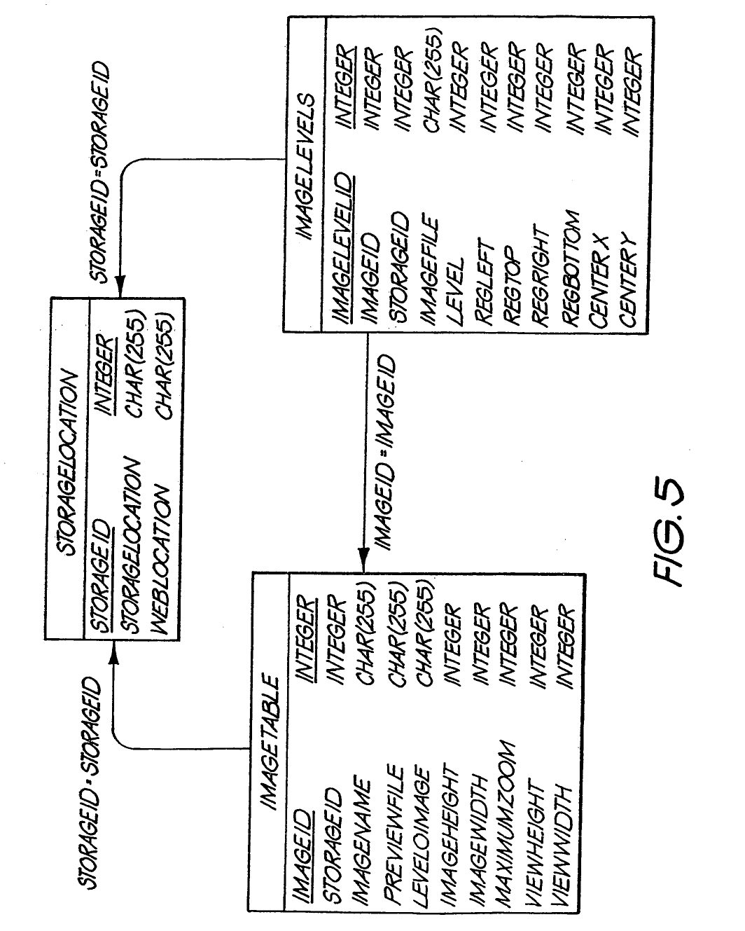

FIG. 5 shows the relationships among data tables of the database 41 according to one embodiment of the present invention.

Database Design

The basic design for the database includes 3 tables:

Storage Location Table: This table indexes the one or more storage locations for the distributed images.

StorageID: A unique identifier for the storage location.

StorageLocation: The physical location for the storage of images. i.e. \\Store1\ImageServer\Files; \\Store2\ImageServer\Files

WebLocation: The web reference to the storage location, for example http://www.irasnet.com/store1/

Image Table: The image table indexes all the images stored in the database. The image table has a reference to the image preview.

ImageID: A unique identifier for the image.

StorageID: A link to the storage location.

ImageName: A unique image name.

PreviewFile: The preview file name including any subdirectories.

Level0Image: A resized image that matches the view area in height and width. This includes the path to the image.

ImageHeight: The height of the original file in pixels.

ImageWidth: The width of the original file in pixels.

Maximum Zoom: The maximum zoom level for this image.

View Height The view height used when processing.

View Width The view width used when processing.

Image Levels table: The image levels table indexes all the tiles for an image in the database.

| | |
|---|---|
| Image ID: | This is an index back to the main entry in the database. |
| Zoom Level: | The zoom level. |
| RegTop: | The top position of the tile in Picture co-ordinates. |
| RegLeft: | The left position of the tile in Picture co-ordinates. |
| RegRight: | The right position of the tile in Picture co-ordinates. |
| RegBottom: | The bottom position of the tile in Picture co-ordinates. |
| Tile Height: | The height of the Image Tile in Picture co-ordinates. |
| Tile Width: | The width of the Image Tile in Picture co-ordinates |
| CenterX: | The center X of the tile in Picture co-ordinates |
| CenterY: | The center Y of the tile in Picture co-ordinates |

It is preferred that the basic database design is be extended to include information relevant to the images in the database. These include:

Scales, in the image table, to convert pixel co-ordinates to physical dimensions; and

locations in picture co-ordinates of interesting features, registered objects and the like.

As explained above, the present invention separates the storage of image files from the tables of the database. According to a particularly preferred embodiment of the invention, the image server uses paths to physically separate the tiles across one or more file systems. The storage location table holds the major store for the images in both physical location and web location. For example the following entries may be made:

| D | Storage Location | Web Location |
|---|---|---|
| | \\Store1\ImageServer\ | http://www.irasnet.com/lsrv/ |
| | Files | |
| | \\Store2\ImageServer\ | http://www.irasnet.com.lsrv2/ |
| | Files | |
| | \\Store1\ImageServer\ | http://www.irasnet.com.au/Images/ |
| | Files2 | |

The above table illustrates how the images can be split over multiple web servers that may be in physically different locations. The location of files can be set up so that a full copy of the image server can be maintained in different locations and the load spread between these servers. This also provides redundancy that leads to 24×7 operation. It is to be understood that, although the above table illustrates solely on-line storage of images, according to other embodiments of the invention image storage can include off-line storage such as in an automated tape library or even in a manual warehousing facility.)

As shown in FIG. 7, the tiles are stored in a tree structure that maintains a maximum number of files in any subdirectory on the storage location. The entries in the Image table and Image levels table includes the path to the image, for example:

\\Store1\ImageServer\Files\Image2\LevelsA\PreviewImage.jpg

\\Store2\ImageServer\Files\Image2589\LevelsA\hhskdsnw11589.jpg

The image storage structure allows images to be move from near-line to off-line storage and back again as the demand dictates.

According to the present embodiment of the invention, the data service node 38 also captures data on the rights of access to image data.

The services controller sub-node 39 controls each of the sub-nodes described above, namely the import services sub-node 26, the image services sub-node 27, the data services sub-node 38, the publishing services sub-node 37 and the database 41. According to some preferred embodiments of the present invention, the services controller sub-node also controls interfacing between the processing node 21 and the distribution node 22.

As explained above, the processing node 21 and the distribution node 22 may be connected by a connection that allows communication in real-time, or the communication between then may be by transport of storage media such as magnetic tape. In the case where there is no real-time connection between these two nodes, data from the database 41 in the processing node 21 is copied into the database 42 in the distribution node 22. Such copying of data between these two nodes may also take place in embodiments in which, for operational or any other reasons, it is not desirable that this data be communicated direct from the processing node through the distribution node and to users.

It is also to be understood that the image files that are described by any data that is copied into database 42 are not themselves copied into that database. These image files may be at or near either the processing node or the distribution node, or may be remote from both of these nodes.

The distribution node includes a web-server 46. The web-server is the point of contact with the distribution node for users who access the image server from a web-browser. As explained above, it is necessary to display an index image to show the user how the current region being viewed relates to the original image. For applications and Java applets this is done on the fly by passing an image to be used and then drawing the physical region under examination onto this at run time. For straight HTML viewing this index image MUST be produced at the same time as tiling. To minimize the storage for these images they are stored at a higher compression ratio and as a smaller image. This is an option that is set prior to the tiling process.

There is a collection of static web pages 47 associated with the web server. These static web pages provide text and other static information to the user. They also provide a facility to the user whereby the user may identify the image data that is required for viewing.

The page provider 48 provides dynamic pages to the user by way of the web server. In particular, the page provider 48 provides display pages incorporating image data to the user by way of the web server. Readily available page provider software such as Sybase's Dynamo, Microsoft's ASP, or PHP are suitable.

The searching services sub-node 49 provides search and inquiry services to the users which are too resource intensive to process on-line. For example, a search inquiry which sought image data on all oil wells which satisfied the search criteria ‘core porosity between X and Y and oil well output greater than Z barrels per day’ may, depending on the amount of image data in the image server, be too large an inquiry to process and/or produce results which are too massive to supply to the user on-line. In such a case, the inquiry may be run separately from the on-line session and the results communicated to the user by some other means.

The application server 51 provides a facility for users to interface with the distribution node 22 otherwise than through a web browser interface. The application server is designed to interface to a specific display client running on user workstations.

The application integrator 52 integrates the operation of each of the above described sub-nodes of the distribution node 22, namely the database 42, the web server 46, the static pages 47, the page provider 48 and the searching services 49 and the application server 51.

It is to be understood that the functions of the distribution node 22 can be served by currently available, proprietary enterprise portal software.

The Zooming and Panning Processes

As described above, in the embodiments of the invention in which the image tiles overlap, it is possible to use that overlap to create the illusion of relative smooth panning. This is achieved on panning by initially re-displaying the area between the adjacent tiles in the display area, and then filling in the rest of the display area from the next tile.

As described above, according to various embodiments of the invention the display client can be a web browser or a an application specific display client. It is not limited to standard HTML or JAVA it can also be incorporated into client/server, activeX, COM or any of the currently utilized distribution methods. Security can be incorporated in several methods from standard SSL to higher levels depending on the application in which the image server is used.

In the case of a display client in the form of a web browser, the ‘image maps’ feature of HTML is used to send back to the server the coordinates of a point within an image where the user has ‘clicked’ with a mouse pointer. This point is, for example, a ‘zoom in’ or ‘panning’ point.

The web sever uses a dynamic page generator such as Sybase Dynamo, PHP or Microsoft ASP. Both the JAVA an HTML pages use the same scripts but the JAVA only passes the results back while the HTML produces a full page.

The Scripts can be divided into four main tasks:

Initial Display

Panning around the image

Zooming in.

Zooming out.

Initial Display:

The initial display assumes that the image has been selected and the ImageID has been passed to the script. The first image to be displayed will always be level 0.

Select Level0Image, WebLocation from Image Table IMG

Left outer join StorageLocation S on S.StorageID=IMG.StorageID

This returns the WebLocation and the Level0Image which are concatenated to produce the reference to the image. The following HTML will display the image and pass back the required variables to the image server.

For Panning:

```
    <A
HREF=“NextView.stm?imageID=1&ImageLevelID=0&
action=pan&level=0&pos=”
>
    <IMG BORDER=“0”
    SRC=HTTP://www.sautec.com.au/IRASNet//ImageStore1/Image2/
LevelsA/PImage.jpg
    HEIGHT=“400”
    WIDTH=“400”
    ISMAP
    ALIGN=“TEXTTOP”
    ALT=“Click anywhere to pan at the current zoom level”>
    </A>
    For Zooming:
    <A HREF=“NextView.stm?imageID=1&
ImageLevelID=1&action=Zoomin&level=0&pos=”>
    <IMG BORDER=“0”
    SRC=HTTP://www.sautec.com.au/IRASNet//ImageStore1/Image2/
LevelsA/PImage.jpg
    HEIGHT=“400”
    WIDTH=“400”
    ISMAP
    A LIGN=“TEXTTOP”
    ALT=“Click anywhere to pan at the current zoom level”>
    </A>
    This returns the variables ImageID, action, level and position clicked
back to the image server in the
    following form:
    http://www.irasnet.com/ImageServer/NextView.stm?imageID=1&
imageLevelID=2&action=pan&level
    =0&pos=?127,69
```

Panning Around the Image:

The script for panning uses the current view to calculate a X-Y co-ordinate in picture co-ordinates and selects the next view. Calculating the X-Y Co-ordinates starts with extracting the X and Y co-ordinates from the “pos” variables. The following code determines the X-Y co-ordinates that have been selected.

If (level = 0) {
Cannot pan around level 0 as we are already viewing the full image.
} else {
SELECT
(regRight-regLeft) / img.ViewWidth scX,
(regBottom-regTop) / img.ViewHeight scY
FROM ImageLevels il
LEFT OUTER JOIN ImageTable img ON img.ImageID=il.ImageID
WHERE ImageLevels={ImageLevelID};
PtX = X * scX;
PtY = Y * scY;
SELECT CenterX-PtX diffX, CenterY-PtY diffY, * FROM ImageLevels
WHERE ImageID={ImageID} and Level={level}
ORDER by diffX DESC, diffY DESC;
}

The results for the SQL Query are used to generate the next HTML page or are passed to the JAVA applet. The SQL Query returns the tile where the center point is nearest to the point clicked.

Zooming In:

The script for zooming in uses the current view to calculate a X-Y co-ordinate in picture co-ordinates and selects the next view. Calculating the X-Y Co-ordinates starts with extracting the X and Y co-ordinates from the “pos” variables. The following code determines the X-Y co-ordinates that have been selected.

```
    SELECT maximumZoom FROM ImageTable WHERE ImageID=
    {ImageID};
    If (level == maximumZoom ) {
    Cannot zoom any further
    } else {
    SELECT
    (regRight-regLeft) / img.ViewWidth scX,
    (regBottom-regTop) / img.ViewHeight scY
    FROM ImageLevels il
    LEFT OUTER JOIN ImageTable img ON img.ImageID=il.ImageID
    WHERE ImageLevels={ImageLevelID};
    PtX = X * scX;
    PtY = Y * scY;
    SELECT CenterX-PtX diffX, CenterY-PtY diffY, * FROM
    ImageLevels WHERE ImageID={ImageID} and Level={level}+1
    ORDER by diffX DESC, diffY DESC;
    }
    The results for the SQL Query are used to generate the next HTML
page or are passed to the JAVA applet. The SQL Query returns the tile
where the center point is nearest to the point clicked.
    Zooming Out:
    The script for zooming out uses the current view to calculate a X-Y
co-ordinate in picture co-ordinates and selects the next view. Calculating
the X-Y Co-ordinates starts with extracting the X and Y co-ordinates from
the “pos” variables. The following code determines the X-Y co-ordinates
that have been selected.
    If (level == 1) {
    SELECT * FROM ImageTable WHERE ImageID={ImageID};
    } else {
    SELECT
    (regRight-regLeft) / img.ViewWidth scX,
    (regBottom-regTop) / img.ViewHeight scY
    FROM ImageLevels il
    LEFT OUTER JOIN ImageTable img ON img.ImageID=il.ImageID
    WHERE ImageLevels={ImageLevelID};
    PtX = X * scX;
    PtY = Y * scY;
    SELECT CenterX-PtX diffX, CenterY-PtY diffY, * FROM
    ImageLevels WHERE ImageID={ImageID} and Level={level}−1
    ORDER by diffX DESC, diffY DESC;
    }
```

The results for the SQL Query are used to generate the next HTML page or are passed to the JAVA applet. The SQL Query returns the tile where the center point is nearest to the point clicked.

Image Tile Archiving

An image can be archived when it is no longer used day to day or is infrequently accessed. Archiving moves the higher zoom levels from on-line storage to off-line storage and marks the relevant rows in the database as off-line.

The following description illustrates the operation of the archiving process where an original (input) image of 10000×10000 pixels is being tiled to a total of four levels for ultimate display in accordance with the present invention on a clients viewing platform which will allow a viewing of an image of 500×500 pixels. The following table sets out the number of image files that will be generated. In the table, the ‘view region’ is the area of the original image that is shown in the viewing area on the client's' platform. The table also assumes an overlap of 50% between adjacent tiles at each level of the tiling hierarchy.

Level 0—1 Image with a view region of 10000×10000

Level 1—9 images with a view region of 5000×5000

Level 2—49 Images with a view region of 2500×2500

Level 3—225 images with a view region of 1250*1250

Level 4—961 Images with a view region of 625*625

This gives a total of 1245 tiles/files (excluding the index tiles) At an average size of 35K per tile the on-line storage requirement is 1245*35K=43.6 Mb.

When this image is archived levels 2 to 4 would be taken off-line. This results in 10 images totaling 350K are left on-line and that 1235 images (totaling 43.2 Mb) are taken off-line. This represents a saving of on-line storage of about (1−(350/43600))*100%=99.2%.

Retrieval of off-line images can be achieved in one of two methods

(1) The individual tile is retrieved.

(2) The entire set of image tiles are retrieved.

In 90% of cases method (2) provides better response as the seek time (time to load tape and index to the image) is much larger than the retrieve time (transfer data from loaded tape to disk).

With modern tape systems the time taken to retrieve information form tape to on-line storage is very responsive and a full set of 1235 tiles could be retrieved in as little time as 60 seconds.

1. A method of segmenting a file, which method includes the steps of:
(a) obtaining a file and storing an identifier of the file in a database;
(b) notionally dividing at least part of the file into a plurality of regions;
(c) for each of the regions:
(i) creating a new file which contains data which is related to the content of the region;
(ii) storing each new file outside the database; and
(iii) storing an identifier of each new file within the database.

2. A method for displaying images to at least one display client over a network, which method includes the steps of:
(a) obtaining an original image file of an image at an original resolution and storing an identifier of the image in a database;
(b) dividing at feast part of the area of the image into a plurality of regions; and
(c) creating an image file for each region at a subsequent resolution which is lower than the original resolution and storing an identifier of each image file of each such region in the database.

3. A method as claimed in claim 2, in which steps (b) and (c) are performed recursively to produce a hierarchy of image files at decreasing resolution levels.

4. A method as claimed in claim 2, in which the regions into which each image is divided are rectangular regions.

5. A method as claimed in claim 4 in which, at each resolution level, each image region overlaps with adjacent image regions.

6. A method as claimed in claim 2 in which the database is a relational database.

7. A method as claimed in claim 2 in which each identifier of an image is the image file name.

8. A method as claimed in claim 2 in which each image file is a graphics format file.

9. A method as claimed in claim 2 in which images are provided to a display client using hypertext transfer protocol (http).

10. A method as claimed in claim 2 in which images are provided to a display client using file transfer protocol (ftp).

11. A method as claimed in claim 2 in which the display client is polled by the image server to ascertain at least one of:
the maximum displayable picture size in pixels; and
the physical size of the picture display area.

12. A method as claimed in claim 2, in which the original image file is generated from any one of:
a frame of a video file;
a vector graphics file; and
a SEG Y file.

13. A method as claimed in claim 2, in which at least one of the plurality of regions into which the image file is divided overlaps with at least one other such region.

14. A method as claimed in claim 2, in which the part of the area of the image file that is divided into a plurality of regions is selected by a process which includes the step of analyzing the contents of the image file to identify objects which are depicted in that file.

15. An image server for the display of images to at least one image display client over a network, which image server includes:
means for storing a set of images, which set of images includes a hierarchy of image files at decreasing resolution levels; and
a database which contains data on each image in the set of images, which database includes data which identifies the location of each image in the stored collection of images.

16. Apparatus for segmenting a file, which apparatus includes means for:
(a) obtaining a file and storing an identifier of the file in a database;
(b) notionally dividing at least part of the file into a plurality of regions; and
(c) for each of the regions:
(i) creating a new file which contains data which is related to the content of the region;
(ii) storing each new file outside the database; and
(iii) storing an identifier of each new file within the database.

17. An image server for displaying images to at least one display client over a network, which image server includes:
(a) means for obtaining an original image file of an image at an original resolution and storing an identifier of the image in a database;
(b) means for dividing at least part of the area of the image into a plurality of regions; and
(c) means for creating an image file for each region at a subsequent resolution which is lower them the original resolution and storing an identifier of each image file of each such region in the database.

18. An image server as claimed in claim 17, in which the means (b) and (c) operate recursively to produce a hierarchy of image files at decreasing resolution levels.

19. An image server as claimed in claim 17 in which the regions into which each image is divided are rectangular regions.

20. An image server as claimed in claim 19 in which, at each resolution level, each image region overlaps with adjacent image regions.

21. An image server as claimed in claim 17 in which the database is a relational database.

22. An image server as claimed in claim 17 in which each identifier of an image is the image file name.

23. An image server as claimed in claim 17 in which each image file is a graphics format file.

24. An image server as claimed in claim 17 in which images are provided to a display client using hypertext transfer protocol (http).

25. An image server as claimed in claim 17 in which images are provided to a display client using file transfer protocol (ftp).

26. An image server as claimed in claim 17 in which the display client is polled by the image server to ascertain at least one of:
the maximum displayable picture size in pixels; and
the physical size of the picture display area.

27. An image server as claimed in claim 17, in which the original image file is generated from any one of:
a frame of a video file;
a vector graphics file; and
a SEG Y file.

28. An image server as claimed in claim 17, in which at least one of the plurality of regions into which the image file is divided overlaps with at least one other such region.

29. An image server as claimed in claim 17, in which the part of the area of the image file that is divided into a plurality of regions is selected by a process which includes the step of analyzing the contents of the image file to identify objects which are depicted in that file.

30. A method of operating an image server to display images over a network to at least one display client, in which method image data is stored at the image server and that image data has been generated by a method which includes:
(a) obtaining an original image file of an image at an original resolution and storing an identifier of the image in a database;
(b) dividing at least part of the area of the image into a plurality of regions; and
(c) creating an image file for each region at a subsequent resolution which is lower than the original resolution and storing an identifier of each image file of each such region in the database.

31. A method as claimed in claim 30, in which steps (b) and (c) are performed recursively to produce a hierarchy of image files at decreasing resolution levels.

32. A method as claimed in claim 30, in which the regions into which each image is divided are rectangular regions.

33. A method as claimed in claim 32 in which, at each resolution level, each image region overlaps with adjacent image regions.

34. A method as claimed in claim 30 in which the database is a relational database.

35. A method as claimed in claim 30 in which each identifier of an image is the image file name.

36. A method as claimed in claim 30 in which each image file is a graphics format file.

37. A method as claimed in claim 30 in which images are provided to a display client using hypertext transfer protocol (http).

38. A method as claimed in claim 30 in which images are provided to a display client using file transfer protocol (ftp).

39. A method as claimed in claim 30 in which the display client is polled by the image server to ascertain at least one of:
the maximum displayable picture size in pixels; and
the physical size of the picture display area.

40. A method as claimed in claim 30, in which the original image file is generated from any one of:
a frame of a video file;
a vector graphics file; and
a SEG Y file.

41. A method as claimed in claim 30, in which at least one of the plurality of regions into which the image file is divided overlaps with at least one other such region.

42. A method as claimed in claim 30, in which the part of the area of the image file that is divided into a plurality of regions is selected by a process which includes the step of analyzing the contents of the image file to identify objects which are depicted in that file.

43. A method of operating an image display client to display images received over a network from at least one image server, in which method the images displayed at the client are derived from image data that is stored at the image server and that stored image data has been generated by a method which includes:
(a) obtaining an original image file of an image at an original resolution and storing an identifier of the image in a database;
(b) dividing at least part of the area of the image into a plurality of regions; and
(c) creating an image file for each region at a subsequent resolution which is lower than the original resolution and storing an identifier of each image file of each such region in the database.

44. A method as claimed in claim 43, in which steps (b) and (c) are performed recursively to produce a hierarchy of image files at decreasing resolution levels.

45. A method as claimed in claim 43, in which the regions into which each image is divided are rectangular regions.

46. A method as claimed in claim 45 in which, at each resolution level, each image region overlaps with adjacent image regions.

47. A method as claimed in claim 43 in which the database is a relational database.

48. A method as claimed in claim 43 in which each identifier of an image is the image file name.

49. A method as claimed in claim 43 in which each image file is a graphics format file.

50. A method as claimed in claim 43 in which images are provided to a-display client using hypertext transfer protocol (http).

51. A method as claimed in claim 43 in which images are provided to a display client using file transfer protocol (ftp).

52. A method as claimed in claim 43 in which the display client is polled by the image server to ascertain at least one of:
the maximum displayable picture size in pixels; and
the physical size of the picture display area.

53. A method as claimed in claim 43, in which the original image file is generated from any one of:
a frame of a video file;
a vector graphics file; and
a SEG Y file.

54. A method as claimed in claim 43, in which at least one of the plurality of regions into which the image file is divided overlaps with at least one other such region.

55. A method as claimed in claim 43, in which the part of the area of the image file that is divided into a plurality of regions is selected by a process which includes the step of analyzing the contents of the image file to identify objects which are depicted in that file.

56. A method for displaying images as claimed in claim 2, substantially as described with reference to the drawings.
